(19) United States
(12) Patent Application Publication
(10) Pub. No.: US 2024/0428293 A1
(43) Pub. Date: Dec. 26, 2024

(54) Purchase-Promoting System

(71) Applicant: Sangeun Kwon, Daegu (KR)

(72) Inventor: Sangeun Kwon, Daegu (KR)

(21) Appl. No.: 18/807,252

(22) Filed: Aug. 16, 2024

Related U.S. Application Data
(63) Continuation of application No. PCT/KR2022/011273, filed on Aug. 1, 2022.

(30) Foreign Application Priority Data
Feb. 16, 2022 (KR) 10-2022-0019911

(51) Int. Cl. G06Q 30/0251; G06Q 30/0601

(52) U.S. Cl. CPC G06Q 30/0253; G06Q 30/0631

(57) ABSTRACT

A purchase-promoting system is disclosed. The disclosed purchase-promoting system is characterized by comprising: a user terminal which is connected to and transmits and receives data with a shopping server via a network, and transmits, to the shopping server, a purchase-desired service selected by a user; a business terminal which is connected to and transmits and receives data with the shopping server via a network, and which finalizes the authorization for the purchase-desired service requested by the user; and the shopping server which is provided with a payment module which provides, to the user terminal or the business terminal, a selection menu for the purchase-desired service name, payment price and payment method, for the payment for the service for which purchase has been requested from the user terminal or the business terminal.

The present disclosure relates to a purchase-promoting system and, more particularly, to a purchase-promoting system, in which an equivalent item presentation module helps the purchase decision of a user by presenting a product or service with a price equivalent to a desired service when paying for an intangible service as a comparison item, and promotes purchasing by presenting an equivalent item that is more frequently used by the general public than the desired service.

### BACKGROUND

These days, consumption of various intangible services is increasing. For example, health training services and financial consulting services, unlike tangible products such as chairs and fountain pens, cannot specify shapes thereof, making it difficult to make an appropriate purchasing decision when purchasing the health training services and financial consulting services.

Payment for these intangible services may be made online via a mobile phone or by visiting a corresponding business location and using a POS terminal or a kiosk provided at the business location.

Previously, only the name of a desired service, a price thereof, and a payment method selection screen were provided at the payment stage of an intangible service.

Because of this, it was difficult for a user to determine the degree of burden that the price of the desired service would impose on the user.

Meanwhile, in the past, in order to promote purchasing, there was no choice but to verbally persuade customers who had difficulty making a purchase decision at a payment stage. Moreover, this is impossible online.

Therefore, from the perspective of business there is an urgent need to develop a new purchase-promoting system that can help a customer make appropriate purchase decision when paying for an intangible service and can promote purchasing.

The present disclosure has been presented to solve the problems described above, and is intended to enable for a user to easily determine the degree of burden by presenting a product or service with a price equivalent to a desired service as a comparison item when paying for an intangible service.

In addition, the present disclosure is intended to promote purchasing by an equivalent item presentation module presenting an equivalent item that is more frequently used by the general public than a desired service.

### SUMMARY

The present disclosure provides a purchase-promoting system for promoting purchasing when paying for a desired service online, the purchase-promoting system including: a user terminal configured to be connected to a shopping server through a network to transmit and receive data, and to transmit a desired service selected by a user to the shopping server;
a business terminal configured to be connected to the shopping server through the network to transmit and receive data, and to process payment for the desired service requested by the user; and
the shopping server provided with a payment module configured to provide a desired service name, a payment price, and a payment method selection menu to the user terminal or the business terminal to pay for the desired service requested for purchase from the user terminal or the business terminal.

In addition, the shopping server of may further include
an equivalent item presentation module configured to transmit information about a product or service with a price equivalent to the desired service to the user terminal or the business terminal,
wherein the equivalent item presentation module may help a purchase decision of the user by presenting, at a purchase stage, the information about the product or service with the price equivalent to the desired service as a comparison item.

In addition, the information presented by the equivalent item presentation module of the present disclosure may be text, an image, or a combination of text and an image.

In addition, the equivalent item presented by the equivalent item presentation module of the present disclosure may be more frequently used by a general public than the desired service.

The purchase-promoting system according to the present disclosure has the effect of enabling for a user to easily determine the degree of burden when paying for an intangible service.

In addition, the purchase-promoting system of the present disclosure has the effect of promoting purchasing when paying for an intangible service.

In addition to the effects described above, the specific effects of the present disclosure are described together with the specific details for implementing the present disclosure below.

### BRIEF DESCRIPTION OF DRAWINGS

FIG. 1 is a view illustrating the configuration of a purchase-promoting system according to the present disclosure.

FIG. 2 is a block diagram of a shopping server according to the present disclosure.

FIG. 3 is a view illustrating a method in which an equivalent item presentation module according to the present disclosure presents an equivalent item.

### DETAILED DESCRIPTION OF EXEMPLARY EMBODIMENTS

Hereinafter, an embodiment of the present document will be described with reference to the accompanying drawings. However, this is not intended to limit the technology described in this document to a specific embodiment, and it should be understood that various modifications, equivalents, and/or alternatives of the embodiment of this document are included. In connection with the description of the drawings, like reference numerals may be used for like components.

In addition, expressions such as “first” and “second” used in this document may modify various elements regardless of order and/or importance, and are used only to distinguish one element from another element but do not limit the corresponding components. For example, “first part” and “second part” may represent different parts regardless of order or importance. For example, without departing from the scope of the claims described in this document, the first component may be named as the second component, and similarly, the second component may also be named as the first component.

In addition, terms used in this document are used only to describe a specific embodiment, and may not be intended to limit the scope of other embodiments. A singular expression may include a plural expression unless the context clearly dictates otherwise. Terms used herein, including technical or scientific terms, may have the same meanings as commonly understood by those skilled in the art described in this document. Among the terms used in this document, terms defined in a general dictionary may be interpreted to have the same or similar meaning as meaning in the context of the related art, and unless explicitly defined in this document, are not interpreted as deal or excessively formal meanings. In some cases, even terms defined in this document cannot be construed to exclude the embodiment of the present document.

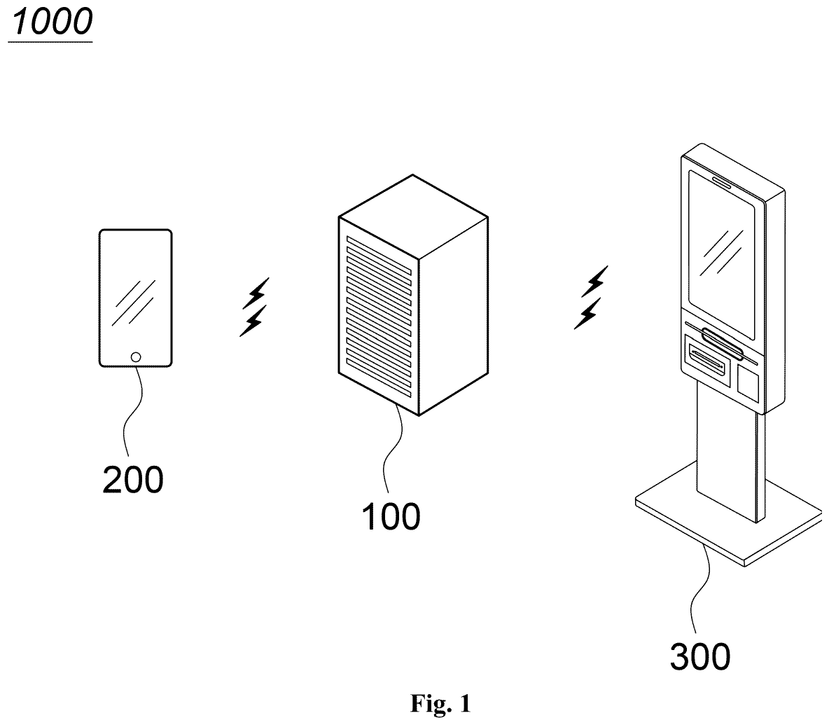

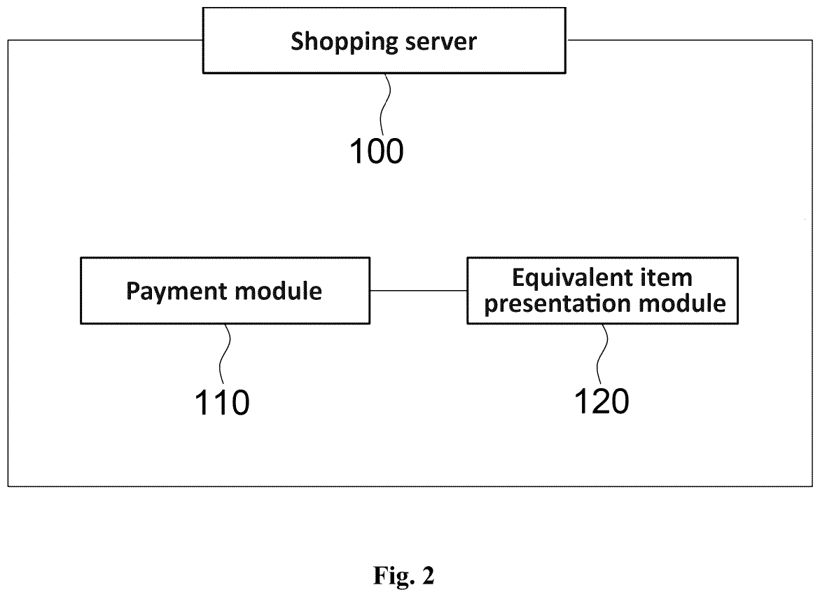

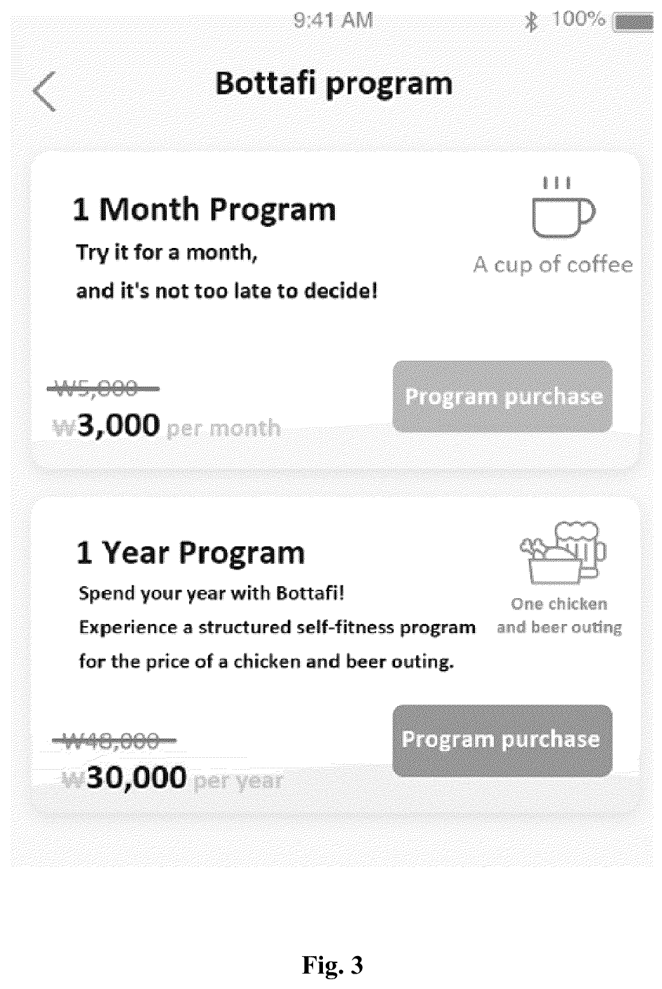

FIG. 1 is a view showing the configuration of a purchase-promoting system 1000 according to the present disclosure, FIG. 2 is a block diagram of a shopping server 100 according to the present disclosure, and FIG. 3 is a view illustrating a method in which an equivalent item presentation module 120 according to the present disclosure presents an equivalent item.

The following description will be made with reference to FIGS. 1 to 3.

The present disclosure relates to the purchase-promoting system 1000 which enables a user to easily determine the degree of burden when paying for an intangible desired service online, and promotes purchasing from the perspective of a seller.

The purchase-promoting system 1000 according to the present disclosure includes a user terminal 200, a business terminal 300, and the shopping server 100.

The user terminal 200 is configured to be connected to the shopping server 100 through a network to transmit and receive data, and to transmit a desired service selected by a user to the shopping server 100.

As the user terminal 200, a mobile phone or a personal computer, etc. may be adopted.

The business terminal 300 is configured to be connected to the shopping server 100 through the network to transmit and receive data, and to process payment for the desired service requested by the user.

As the business terminal 300, a POS terminal, a personal computer, or a kiosk, etc. may be adopted.

The shopping server 100 provides a payment environment for a service requested for purchase by a user.

A payment module 110 provided in the shopping server 100 provides, at a purchase stage, a desired service name, a payment price, and a payment method selection menu to the user terminal 200 or the business terminal 300.

Previously, when paying for an intangible service, only the name of a desired service, a price thereof, and a payment method selection screen were provided.

Because of this, it was difficult for a user to determine the degree of burden that the price of an intangible service, such as consulting fees, would impose on the user.

Accordingly, in the present disclosure, a comparison item is provided during the payment stage for an intangible service to assist a user in making a purchase decision.

The equivalent item presentation module 120 provided in the shopping server 100 is configured to transmit information about a product or service with a price equivalent to the desired service to the user terminal 200 or the business terminal 300.

The information provided by the equivalent item presentation module 120 may consist of text, an image, or a combination of text and an image.

FIG. 3 is a screen for paying a fee for a fitness program.

As illustrated in FIG. 3, the text of “a cup of coffee” and an image thereof are presented as an item equivalent to 3,000 won, a monthly fee for the fitness program.

A user may perceive the monthly fee of 3,000 won for the fitness program as a burden similar to buying a cup of coffee, which will help the user make a purchase decision.

The vagueness of purchasing an intangible service without any comparison item is resolved by providing a comparison item. That is, it allows for a user to easily determine the degree of a burden imposed on the user.

An equivalent item presented by the equivalent item presentation module 120 is an item that is more frequently used by the general public than a desired service.

That is, by presenting an item with high frequency of use in daily life, such as a cup of coffee or a meal of chicken and beer, it encourages a user to make purchasing decisions more easily.

That is, by allowing the monthly fee of 3000 won for a fitness program to be perceived as equivalent to the cost of a cup of coffee, which is purchased multiple times a day, a user who is hesitant to complete the purchase may be encouraged to pay for the program.

This may be more effective than promoting the service verbally.

The present disclosure relates to the purchase-promoting system 1000 and, more particularly, to the purchase-promoting system 1000, in which the equivalent item presentation module 120 provides a product or service with a price equivalent to a desired service when paying for an intangible service to help the purchase decision of a user through comparison, and promotes purchase by presenting an equivalent item that is more frequently used by the general public than the desired service.

In the above, the exemplary embodiment of the present disclosure has been illustrated and described, but the present disclosure is not limited to the specific embodiment described above. Various modifications of the embodiment may be made by those of ordinary skill in the technical field to which the invention belongs without departing from the gist of the present disclosure claimed in the claims. These modified embodiments should not be individually understood from the technical spirit or prospect of the present disclosure.

1. A purchase-promoting system (1000) for promoting purchasing when paying for a desired service online, the purchase-promoting system comprising:
a user terminal (200) configured to be connected to a shopping server (100) through a network to transmit and receive data, and to transmit a desired service selected by a user to the shopping server (100);
a business terminal (300) configured to be connected to the shopping server (100) through the network to transmit and receive data, and to process payment for the desired service requested by the user; and
the shopping server (100) provided with a payment module (110) configured to provide a desired service name, a payment price, and a payment method selection menu to the user terminal (200) or the business terminal (300) to pay for the desired service requested for purchase from the user terminal (200) or the business terminal (300).

2. The purchase-promoting system of claim 1, wherein the shopping server (100) further includes an equivalent item presentation module (120) configured to transmit information about a product or service with a price equivalent to the desired service to the user terminal (200) or the business terminal (300),
wherein the equivalent item presentation module (120) helps a purchase decision of the user by presenting, at a purchase stage, the information about the product or service with the price equivalent to the desired service as a comparison item.

3. The purchase-promoting system of claim 2, wherein the information presented by the equivalent item presentation module (120) is text, an image, or a combination of text and an image.

4. The purchase-promoting system of claim 2, wherein the equivalent item presented by the equivalent item presentation module (120) is more frequently used by a general public than the desired service.
